(19) United States
(12) Patent Application Publication
(10) Pub. No.: US 2007/0127980 A1
(43) Pub. Date: Jun. 7, 2007

(54) Lotion/oil roller applicator

(76) Inventor: Daniel C. Tamez, Plano, TX (US)

Correspondence Address: MICHAEL L. DIAZ, P.C., 555 REPUBLIC DRIVE, SUITE 200, PIANO, TX, 75074, US

(21) Appl. No.: 11/295,056

(22) Filed: Dec. 6, 2005

(51) Int. Cl. B05C 17/03; A46B 5/02

(52) U.S. Cl. 401/197; 401/6

(57) ABSTRACT

An applicator for applying lotion/oil to a body of a user. The applicator includes an elongated handle having an area for storing the lotion/oil. A roller applicator head is attached to a first end of the elongated handle. The roller applicator head has a roller with a hollow interior portion, a moveable cylinder having a plurality of apertures positioned within the hollow interior portion, and a plurality of channels leading from the cylinder to an inner surface of the roller. The moveable cylinder moves between a first position wherein the plurality of apertures are aligned with the channels leading to the roller and a second position wherein the plurality of apertures are misaligned with the channels. By moving the cylinder to the first position the lotion/oil stored within the elongated handle runs into the cylinder and out through the plurality of apertures and the plurality of channels to the inner surface and saturating the inner surface and soaking to an outer surface of the roller. The user applies the roller to the user, thus dispensing lotion/oil onto the user.

### BACKGROUND OF THE INVENTION

1. Technical Field of the Invention

This invention relates to lotion applicators and, more particularly, to a lotion application having a roller system for providing a desired amount of lotion or oil to a person's skin.

2. Description of Related Art

The application of lotion or oil to a person's body can be messy, as well as being difficult to apply uniformly and smoothly to one's skin. There are numerous devices which allow a person to apply the lotion to one's skin without touching the lotion. However, most of these existing applicators require that the lotion be applied to a sponge applicator. Additionally, there are several existing devices which utilize a reservoir to store and apply the lotion/oil to a sponge application. However, none of the existing devices provide a mechanism for delivering the lotion in a desired amount to a sponge applicator which uniformly applies the lotion to the skin. An apparatus is needed which allows the uniform application of lotion/oil to the skin through the use of a roller applicator while allowing the operator to set the desired amount of lotion to the roller applicator.

Although there are no known prior art teachings of a solution to the aforementioned deficiency and shortcoming such as that disclosed herein, prior art references that discuss subject matter that bears some relation to matters discussed herein are U.S. Pat. No. 4,961,661 to Sutton et al. (Sutton), U.S. Pat. No. 5,240,339 to DeForest et al. (DeForest), and U.S. Pat. No. 5,845,659 to Hutchins (Hutchins). Sutton discloses a fluid applicator which applies a fluid to a remote surface. The applicator has a fibrous pad which is saturated and retains the fluid until applied to a surface. A valve is used to control the amount of fluid in the fibrous pad and a telescoping hand element is extended to provide an elongated handle for reaching remote areas. However, Sutton does not teach or suggest the use of a roller applicator. Sutton merely discloses a device which includes a flat surface for applying a fluid. Sutton suffers from the disadvantage of utilizing a flat pad to apply the fluid to a surface.

DeForest discloses a body lotion applicator with an extended applicator head for reaching the back and other portions of the body that may be difficult to reach. An elongated arm is used as a handle and conduit for conducting body lotions from a conventional bottle to the applicator head. The applicator head includes a face plate and porous sponge affixed by a retaining ring. The sponge includes an outer layer of a small cell, open-cell foam. However, DeForest does not teach or suggest the use of a roller applicator or a mechanism to properly meter the lotion to the sponge.

Hutchins discloses a lotion applicator having an elongated handle where a supply of lotion is stored. The applicator is a cylindrically shaped sponge roller. The lotion is delivered to the sponge roller by a plurality of freely rotatable applicator balls which are in communication with a reservoir of lotion. The balls are provided with grooves which allow the lotion to be delivered to the sponge roller. The rotatable movement of the sponge roller effects the concurrent motion of the applicator balls to maintain a continuous supply of lotion to the roller. Although Hutchins discloses a roller applicator, Hutchins does not teach or suggest a mechanism to allow the user to meter a desired amount of lotion of the applicator. Hutchins merely allows a predetermined amount of the lotion to be metered to the roller applicator by movement of the roller applicator. Additionally, Hutchins suffers from the disadvantage of utilizing a costly and complicated mechanism to deliver the lotion to the roller applicator. Hutchins also requires the user to spin the roller numerous times to thoroughly and evenly saturate the roller applicator.

Thus, it would be a distinct advantage to have an apparatus which allows the uniform application of lotion/oil to a body by user of a roller applicator as well as a mechanism which meters a desired amount of lotion/oil of the roller applicator. It is an object of the present invention to provide such an apparatus.

### SUMMARY OF THE INVENTION

In one aspect, the present invention is an applicator for applying lotion/oil to a body of a user. The applicator includes an elongated handle having a storage area for storing the lotion/oil. The elongated handle has a first end and an opposite second end. A roller applicator is attached to the first end of the elongated handle. The roller applicator has a roller with a hollow interior portion, a moveable cylinder having a plurality of apertures positioned within the hollow interior portion, and a plurality of channels leading from the cylinder to an inner surface of the roller. The moveable cylinder moves between a first position wherein the plurality of apertures are aligned with the channels leading to the roller and a second position wherein the plurality of apertures are misaligned with the channel. The user moves the moveable cylinder to the first position to allow the lotion/oil stored within the elongated handle to run into the cylinder and out through the plurality of apertures and the plurality of channels to the inner surface, thereby saturating the inner surface and soaking an outer surface of the roller.

In another aspect, the present invention is an applicator for applying lotion/oil to a body of a user. The lotion/oil applicator includes an elongated handle having a storage area for storing the lotion/oil. The elongated handle has a first end and an opposite second end. In addition, a roller applicator is attached to the first end of the elongated handle. The roller applicator has a rotatable roller with a hollow interior portion. The lotion/oil is metered to the hollow interior portion of the roller. The user meters the lotion/oil stored within the elongated handle to the hollow interior portion onto an inner surface of the roller, which saturates the inner surface and soaks an outer surface of the roller.

In one embodiment of the present invention, the applicator includes a moveable cylinder positioned within the hollow portion of the applicator which enables the lotion/oil to be metered to the inner surface of the roller. In another embodiment, the cylinder is longitudinally moved to align apertures in the cylinder with channels or apertures, thereby allowing the passage of the lotion/oil. In another embodiment, the cylinder is rotated to allow alignment of the apertures. In still another embodiment, the apertures are covered by covers attached to supports. The covers may be moved to allow the lotion/oil to flow through the apertures.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a side elevational view of a lotion applicator in the preferred embodiment of the present invention;

FIG. 2 is a cross-sectional view of the lotion applicator of FIG. 1;

FIG. 3 is a cross-sectional view of the lotion applicator of FIG. 1 in the open position;

FIG. 4 is a front perspective view of the roller applicator with the roller shield and a rotating end in the open position;

FIG. 5 is a front perspective view of the roller applicator removed from the lotion applicator;

FIG. 6 is a cross-sectional view of a lotion applicator in a first alternate embodiment of the present invention;

FIG. 7 is a side cross-sectional view of the coil mechanism of FIG. 6;

FIG. 8 is a cross-sectional view of a lotion applicator in a second alternate embodiment of the present invention;

FIG. 9 is a cross-sectional view of a lotion applicator in a closed position in a third alternate embodiment of the present invention; and

FIG. 10 is a cross-sectional view of the lotion applicator of FIG. 9 in an open position.

### DETAILED DESCRIPTION OF EMBODIMENTS

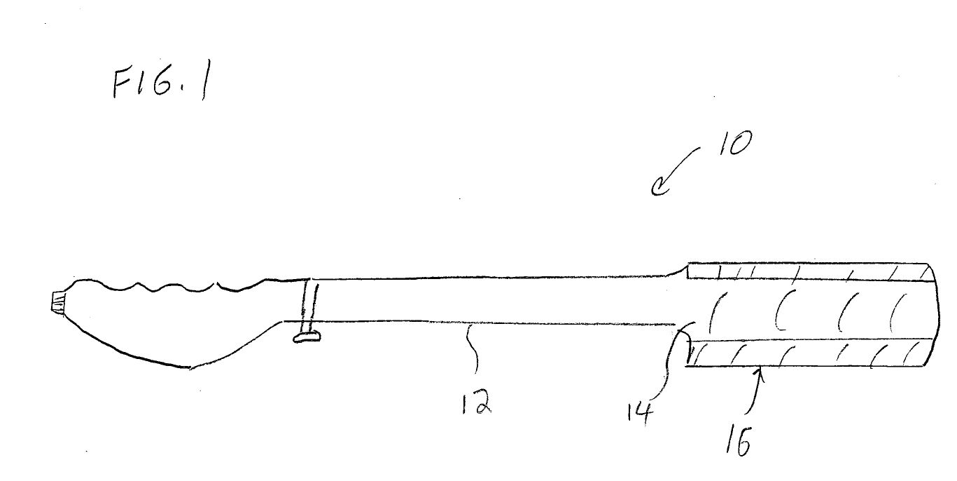

The present invention is an apparatus for uniformly applying lotion or oil to a body in a desired amount by the user. FIG. 1 is a side elevational view of a lotion applicator 10 in the preferred embodiment of the present invention. The lotion applicator includes an elongated handle 12, a roller applicator 14, and a shield 16.

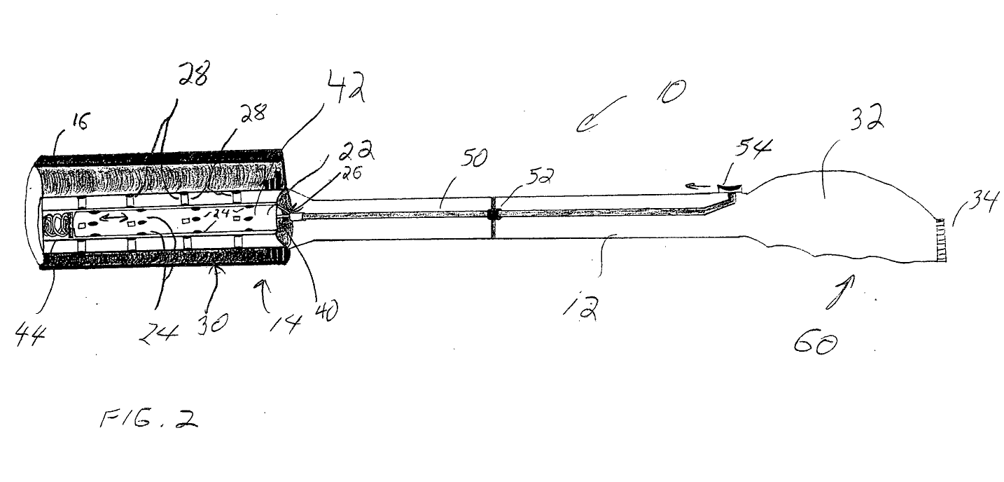

FIG. 2 is a cross-sectional view of the lotion applicator 10 of FIG. 1. The lotion applicator includes a resilient surface, such as a sponge or absorbent material, located around the roller applicator. The roller applicator is preferably cylindrical in shape. Preferably, the roller applicator is mounted to the lotion applicator to allow circular movement. Within an interior portion of the roller applicator is a cylinder 22 having a plurality of apertures 24. The cylinder is longitudinally moveable within a chamber 26 of the roller applicator. The cylinder is hollow and allows the movement of lotion/oil through the apertures. A plurality of channels 28 are located circumferentially about several locations leading from an outer surface 30 to an inner surface of the resilient surface. The channels are positioned at various locations on the resilient surface, thereby allowing a relatively even distribution of lotion/oil onto the roller applicator.

Within the elongated handle 12 is a reservoir 32 storing oil or lotion. The reservoir may be located within a portion or through an interior portion running the length of the elongated handle. As illustrated and in the preferred embodiment of the present invention, the lotion/oil is stored throughout the entire length of the elongated handle. Preferably, at a top portion of the elongated handle is a removable cap 34 covering an opening into the interior portion of the handle, thereby allowing the replenishment of the lotion/oil into the reservoir. The elongated handle may be optionally extendible (e.g., telescopically).

Upon a top portion of the cylinder is an opening 40, allowing passage of the lotion/oil into an interior hollow area 42 of the cylinder. On a bottom portion of the cylinder is a spring 44 which biases the cylinder to a closed position.

To facilitate longitudinal movement of the cylinder in relation to the roller applicator 14, an actuating rod 50 is attached to the top of the cylinder. The actuating rod runs from the cylinder within the interior of the elongated handle 12 through a support 52 located at approximately a middle position or beyond towards the top portion of the elongated handle. The support allows the actuating rod to slide free through the support. The actuating rod is attached to an actuation button 54 located on the exterior of the elongated handle. Sliding the actuating button towards the roller causes the rod to press downwardly upon the cylinder.

Although a slide mechanism is illustrated, any device allowing movement of the cylinder may be used. In addition, the elongated handle may be contoured to accommodate a hand on the top portion of the handle, such as a grip 60.

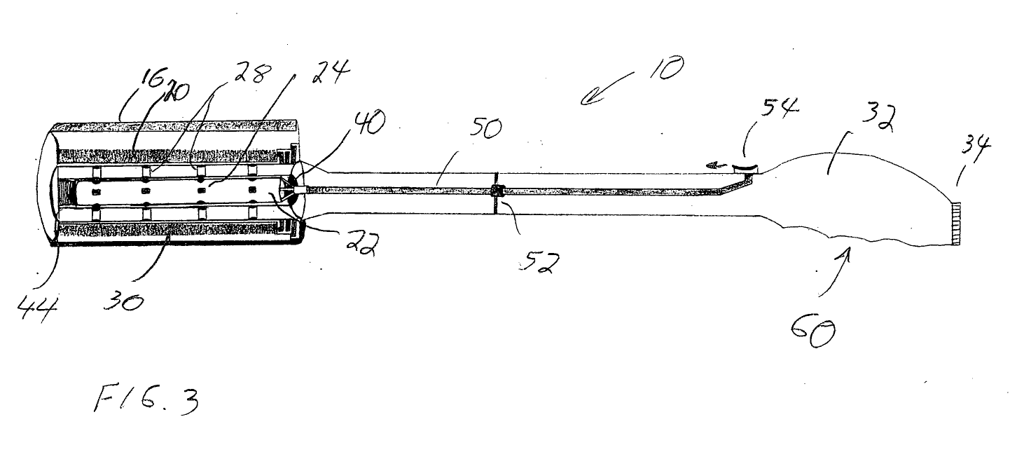

FIG. 3 is a cross-sectional view of the lotion applicator 10 of FIG. 1 in the open position. The lotion applicator is operated in the open position by depressing the actuation button 54, thereby causing the longitudinal translation of the cylinder to a position aligning the apertures 24 with the fixed channels 28.

With reference to FIGS. 1-3, the operation of the lotion applicator will now be explained. Prior to use of the lotion applicator, lotion or oil is inserted through the removable cap 34 into the interior of the elongated handle 12. The lotion/oil travels through the interior area of the elongated handle, through the opening 40 into the hollow area of the cylinder 22. Since the apertures 24 are not aligned with the channels 28 in the closed position, the lotion/oil is contained within the lotion applicator 10. The lotion applicator and its stored oil/lotion may be transported or stored without leakage of the lotion/oil from the lotion applicator.

When the user desires to apply the lotion/oil to his body, the user slides the actuation button 54 downward. Sliding the actuation button downward causes the actuating rod to move downward, thereby forcing the cylinder to move downwardly. The activation button must be held down to hold the cylinder in the depressed (open) position, as depicted in FIG. 3. With the cylinder held in the open position, the apertures 24 of the cylinder are aligned with channels 28 leading to the roller applicator 14. With the apertures and the channels aligned, lotion/oil contained in the hollow area 42 is allowed to pass through the channels and onto an inner surface of the resilient surface 20. The lotion/oil soaks through the resilient surface to its outer surface. The user applies the roller to his skin as needed. The user may apply as much lotion/oil as desired to the roller applicator. When sufficient lotion/oil is applied to the resilient surface, the user may release the actuation button 54. Upon releasing the button, the cylinder is pushed upwardly by the spring 44, which moves the cylinder to a position which misaligns the apertures in relation to the channels, thereby preventing passage of the lotion/oil out through the channel.

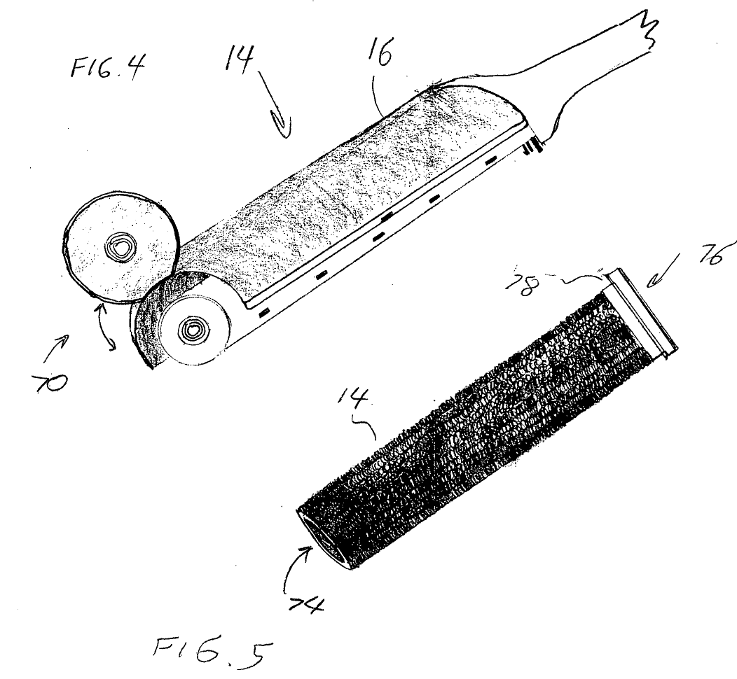

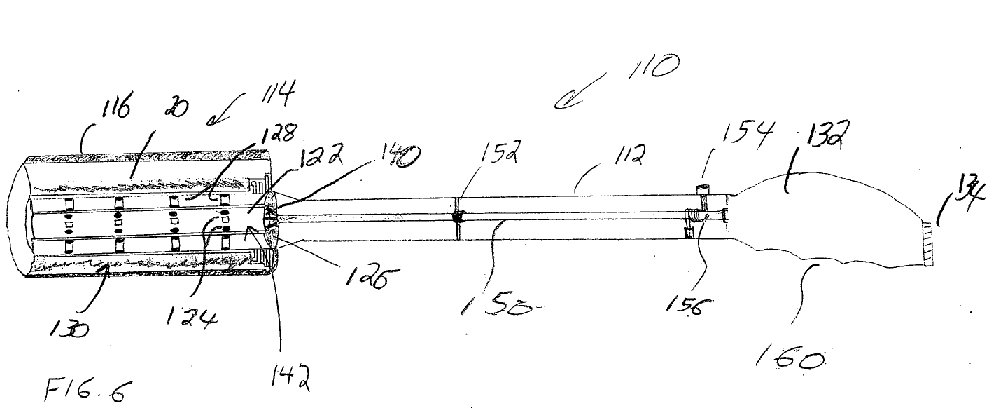

FIG. 4 is a front perspective view of the roller applicator 14 with the roller shield 16 and a rotating end 70 in the open position. The roller applicator may be removed (FIG. 5) as necessary. The roller applicator is removed with the rotating end in the open position. It should be understood that the rotating end is optional. To hold the roller applicator in place, the rotating end 70 may be positioned to a closed position, thereby preventing the roller applicator from inadvertently being removed from the lotion applicator. Additionally, the roller applicator may be locked into place by a catch mechanism (not shown) to hold the roller in place. The roller shield prevents accidental application of lotion/oil from the roller applicator other than direct application to the skin. The shield is preferably a hard plastic and positioned on a portion of the roller applicator which faces the user of the roller applicator.

FIG. 5 is a front perspective view of the roller applicator 14 removed from the lotion applicator 10. The roller applicator may be removed, allowing replacement or cleaning of the used roller applicator. Preferably, the roller applicator includes a bore 74 running through the length of the roller applicator. The roller applicator may include a fixed end 76 having an indented inner lip 78. The inner lip may be used to fix the roller applicator in the locked position to the lotion applicator.

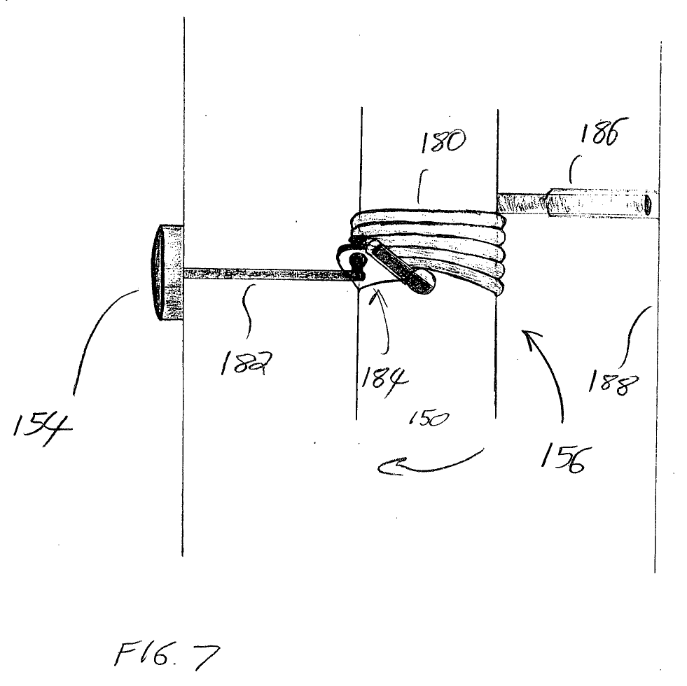

In alternate embodiments, the cylinder may be rotated to allow the lotion or oil to be applied to the roller applicator. FIG. 6 is a cross-sectional view of a lotion applicator 110 in a first alternate embodiment of the present invention. The lotion applicator includes an elongated handle 112, a roller applicator 114, and a shield 116. The lotion applicator includes a resilient surface, such as a sponge or absorbent material, located around the roller applicator. Within an interior portion of the roller applicator is a cylinder 122 having a plurality of apertures 124. The cylinder is rotatable about its longitudinal axis and positioned within a chamber 126 of the roller applicator. The cylinder is hollow and allows the movement of lotion/oil through the apertures. A plurality of channels 128 are located circumferentially about several locations leading from an outer surface 130 to an inner surface of the resilient surface. The channels are positioned at various locations on the resilient surface, thereby allowing a relatively even distribution of lotion/oil onto the roller applicator.

Within the elongated handle 112 is a reservoir 132 storing oil or lotion. The reservoir may be located within a portion or through an interior portion running the length of the elongated handle. Preferably, at a top portion of the elongated handle is a removable cap 134 covering an opening into the interior portion of the handle, thereby allowing the replenishment of the lotion/oil into the reservoir. The elongated handle may be optionally extendible (e.g., telescopically).

Upon a top portion of the cylinder is an opening 140, allowing passage of the lotion/oil into an interior hollow area 142 of the cylinder. The elongated handle may be contoured to accommodate a hand on the top portion of the handle, such as a grip 60.

To facilitate rotation of the cylinder in relation to the roller applicator 114, an actuating rod 150 is attached to the top of the cylinder. The actuating rod runs from the cylinder within the interior of the elongated handle 112 through a support 152 located at approximately a middle position or beyond towards the top portion of the elongated handle. The support allows the actuating rod to rotate freely through the support. The actuating rod is connected to an actuation button 154 by a coil mechanism 156. Depression of the actuating button enables the actuating rod to rotate.

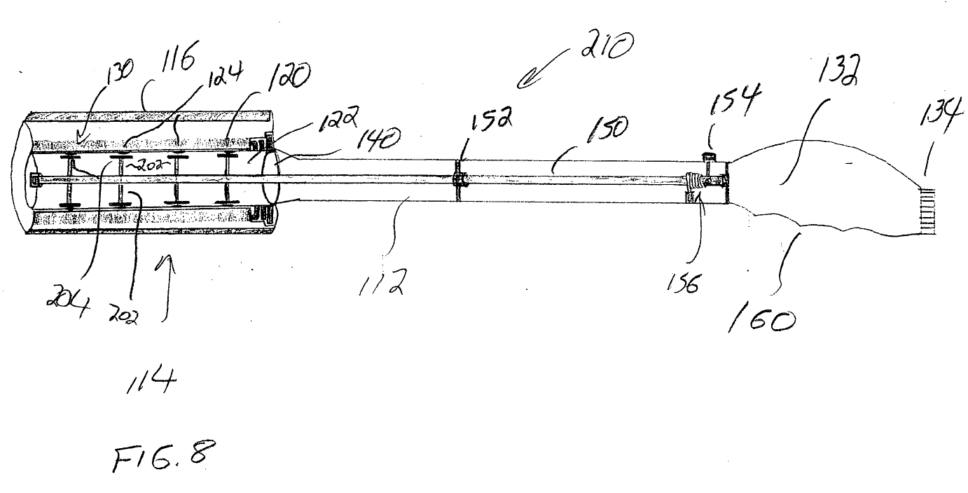

FIG. 7 is a side cross-sectional view of the coil mechanism 156 of FIG. 6. The coil mechanism includes a coil 180 wrapped around the actuating rod 150. The coil mechanism is attached to an extension 182 which, in turn is connected to the actuation button 154. The extension is connected to the coil at a retaining clip 184. Additionally, the coil is connected on an opposing side with an extension 186 which is affixed to an opposite side of the handle. When the actuation button is depressed, force is applied to the extension 182 which provides a force to the retaining clip. The retaining clip moves the coil, thereby allowing the actuating rod to rotate. When the actuation button is released, the extension 186 applies force in the opposition rotational direction. The extension provides a bias to the actuating rod to remained in a specific position which places the cylinder in the closed position.

The lotion application 110 operates in a similar fashion as the lotion application 10. With reference to FIGS. 6 and 7, the operation of the lotion applicator will now be explained. Prior to use of the lotion applicator, lotion or oil is inserted through the removable cap 134 into the interior of the elongated handle 112. The lotion/oil travels through the interior area of the elongated handle, through the opening 140 into the hollow area of the cylinder 122. Since the apertures 124 are not aligned with the channels 128 in the closed position, the lotion/oil is contained within the lotion applicator 110. The lotion applicator and its stored oil/lotion may be transported or stored without leakage of the lotion/oil from the lotion applicator.

When the user desires to apply the lotion/oil to his body, the user depresses the actuation button 154. As discussed above, depression of the actuation button downward causes the actuating rod to rotate, thereby rotating the cylinder. The activation button must remain depressed to hold the cylinder in the open (rotated) position. With the cylinder held in the open position, the apertures 124 of the cylinder are aligned with the channels 128 leading to the roller applicator 114. With the apertures and the channels aligned, lotion/oil contained in the hollow area 142 is allowed to pass through the channels and onto an inner surface of the resilient surface 120. The lotion/oil soaks through the resilient surface to its outer surface. The user applies the roller to his skin as needed. The user may apply or meter as much lotion/oil as desired to the roller applicator. When sufficient lotion/oil is applied to the resilient surface, the user may release the actuation button 54. Upon releasing the button, the cylinder is rotated back to its original position, which moves the cylinder to a position which misaligns the apertures in relation to the channels, thereby preventing passage of the lotion/oil out through the channel.

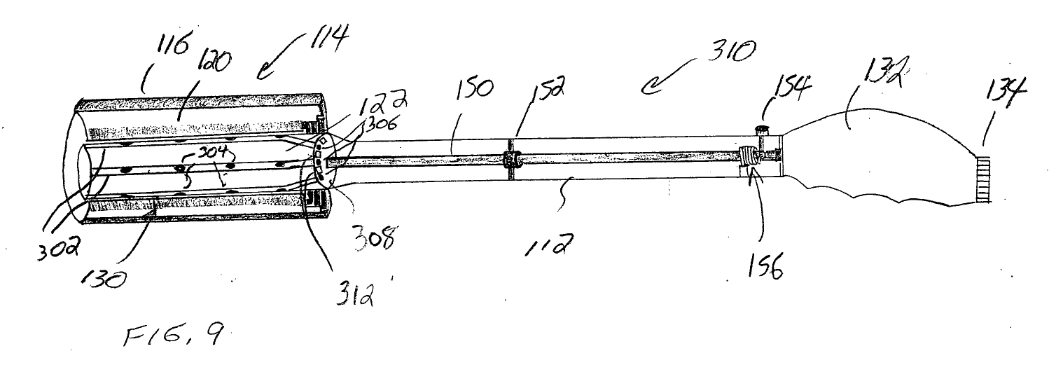

FIG. 8 is a cross-sectional view of a lotion applicator 210 in a second alternate embodiment of the present invention. The lotion applicator 210 is similar to the lotion applicator 110. The lotion applicator 210 differs in that the cylinder 122 of the applicator 210 includes supports 202 affixed to covers 204 rather than utilizing channels. The covers 204 are sized to fit over the apertures 124. In the closed position, as depicted in FIG. 8, the covers cover the apertures 124. When the actuation button 154 is depressed, the actuating rod 150 is rotated, thereby rotating the cylinder. When the cylinder is rotated, the covers are moved away from the apertures, which allows the oil/lotion to flow to the inner side of the outer surface 130 of the roller applicator 114. By releasing the actuation button, the actuating rod and cylinder are rotated back to their original position, which positions the covers over the apertures.

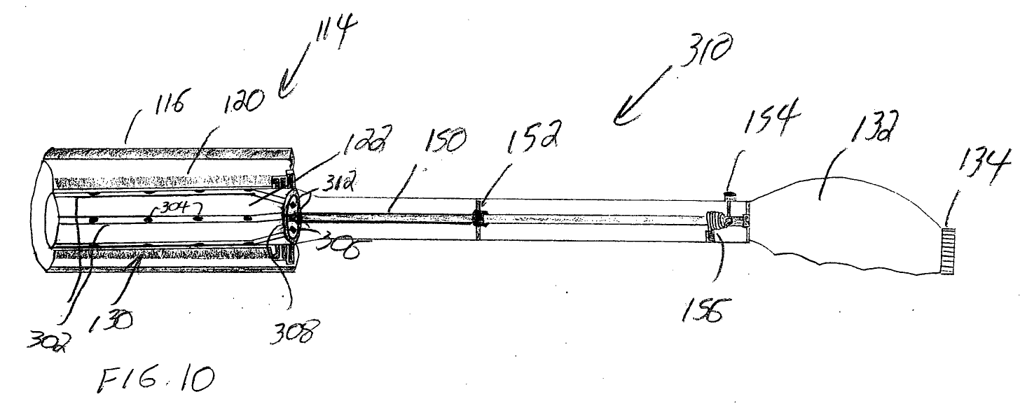

FIG. 9 is a cross-sectional view of a lotion applicator 310 in a closed position in a third alternate embodiment of the present invention. The lotion applicator 310 is similar to the lotion applicators 110 and 210 having a rotatable cylinder. In this alternate embodiment, the cylinder includes longitudinally aligned conduits 302 having a plurality of apertures 304. At the top of the cylinder is a plurality of openings 306 covered by an end portion 308. The end portion may include a plurality of end openings 312. In the closed position depicted in FIG. 9, the end cover covers the openings 306. In this position, the end openings are not aligned with the openings 306, thereby preventing lotion/oil from entering to the longitudinally aligned conduits 302.

FIG. 10 is a cross-sectional view of the lotion applicator 310 of FIG. 9 in an open position. When a user depresses the actuation button, the cylinder rotates, thereby aligning the openings 306 with the end openings 312. With the openings aligned with the end openings, lotion or oil may flow into the conduits 302, through the apertures 304 onto the roller applicator. When the actuation button is released, the cylinder is rotated back to its original position, where the opening and end openings are misaligned, thereby preventing passage of lotion/oil into the conduits. In an alternate embodiment of the present invention, the cover may be attached to the cylinder and the cover allowed to rotate with the cylinder being held stationary. With rotation of the cover, the openings and end openings may be aligned or misaligned to allow the passage of the lotion/oil as desired.

It should be understood, that any mechanism which allows the oil/lotion to flow from the elongated handle into an inside portion of the roller applicator and allowed to soak through to the outer surface may be utilized and is within the scope of the present invention. Thus, any device which meters the lotion/oil into the inside portion of the roller application may be utilized.

The present invention provides several advantages of existing devices. The lotion applicator provides a novel device which dispenses or meters a desired amount of lotion or oil onto a roller applicator. In addition, the application of the lotion or oil to the roller applicator is evenly distributed, thus allowing ease in application of the lotion/oil to the skin. The lotion applicator also utilizes a cost-effective mechanism that allows lotion or oil to be replenished within the lotion applicator.

It is thus believed that the operation and construction of the present invention will be apparent from the foregoing description. While the apparatus shown and described have been characterized as being preferred, it will be readily apparent that various changes and modifications could be made therein without departing from the scope of the invention as defined in the following claims.

What is claimed is:

1. A lotion/oil applicator for applying lotion/oil to a body of a user, said lotion applicator comprising:
an elongated handle having a storage area for storing the lotion/oil, said elongated handle having a first end and an opposite second end;
a roller applicator attached to the first end of said elongated handle, said roller applicator having a roller with a hollow interior portion, a moveable cylinder having a plurality of apertures positioned within the hollow interior portion, a plurality of channels leading from the cylinder to an inner surface of the roller;
the moveable cylinder moving between a first position wherein the plurality of apertures are aligned with the channels leading to the roller and a second position wherein the plurality of apertures are misaligned with the channels;
means for moving the moveable cylinder from the first position to the second position;
whereby the user moves the moveable cylinder to the second position to allow the lotion/oil stored within the elongated handle to run out through the plurality of apertures and the plurality of channels to the inner surface, thereby saturating the inner surface and soaking an outer surface of the roller and whereby the user applies the roller to the user to dispense lotion/oil to the user.

2. The lotion/oil applicator for applying lotion/oil to a body of a user of claim 1 wherein:
the cylinder moves longitudinally from the first position to the second position; and
further comprising a spring located at an end of the moveable cylinder, the spring biasing the moveable cylinder to the first position.

3. The lotion/oil applicator for applying lotion/oil to a body of a user of claim 1 wherein the means for moving the moveable cylinder from the first position to the second position includes an actuating rod mechanically connected to a slidable actuation button, the movement of the actuation button causing the actuating rod to move toward the first end, thereby moving the moveable cylinder to the second position.

4. The lotion/oil applicator for applying lotion/oil to a body of a user of claim 1 wherein the second end of the elongated handle includes a grip contoured to a hand.

5. The lotion/oil applicator for applying lotion/oil to a body of a user of claim 1 wherein the second end includes a removable cap covering an opening leading to the storage area and wherein lotion/oil may be inserted through the opening into the storage area.

6. The lotion/oil applicator for applying lotion/oil to a body of a user of claim 1 further comprising a moveable shield affixed to the roller applicator, said shield providing a closed position for covering a portion of the roller applicator and an open position for accessing the roller applicator.

7. The lotion/oil applicator for applying lotion/oil to a body of a user of claim 1 wherein the roller applicator is removably attached to the lotion/oil applicator.

8. The lotion/oil applicator for applying lotion/oil to a body of a user of claim 1 wherein the cylinder rotates from the first position to the second position.

9. The lotion/oil applicator for applying lotion/oil to a body of a user of claim 8 wherein the means for moving the moveable cylinder from the first position to the second position includes an actuating rod mechanically connected to an actuation button, the movement of the actuation button causing the actuating rod to rotate, thereby moving the moveable cylinder to the second position.

10. The lotion/oil applicator for applying lotion/oil to a body of a user of claim 9 further comprising:
a coil mechanism mechanically connected to the actuating rod and the actuation button; and
wherein the coil mechanism enables depression of the actuation button to rotate the actuating rod for rotating the cylinder.

11. A lotion/oil applicator for applying lotion/oil to a body of a user, said lotion applicator comprising:
an elongated handle having a storage area for storing the lotion/oil, said elongated handle having a first end and an opposite second end;
a roller applicator attached to the first end of said elongated handle, said roller applicator having a rotatable roller with a hollow interior portion;
means for metering lotion/oil to the hollow interior portion of the roller;
whereby the user meters the lotion/oil stored within the elongated handle to the hollow interior portion onto an inner surface of the roller, thereby saturating the inner surface and soaking an outer surface of the roller and whereby the roller is applied to the user to dispense lotion/oil to the user.

12. The lotion/oil applicator of claim 11 wherein the means for metering lotion/oil to the hollow interior portion of the roller includes:
a plurality of conduits having a plurality of apertures;
means for metering lotion/oil into the plurality of conduits;
whereby the lotion/oil is applied through the plurality of conduits into the apertures to the inner surface of the roller.

13. The lotion/oil applicator of claim 12 wherein the means for metering lotion/oil into the plurality of conduits includes at least one closeable opening located between the conduits and the storage area of the lotion/oil.

14. The lotion/oil applicator of claim 11 wherein the means for metering lotion/oil to the hollow interior portion of the roller includes:
a cylinder located within the hollow interior portion, the cylinder having a plurality of apertures;
whereby the lotion/oil is metered through the apertures onto the inner surface of the roller.

15. The lotion/oil applicator of claim 14 wherein:
the cylinder is moveable from a first position to a second position, in the first position the apertures being in a closed position and in the second position the apertures being in an open position.

16. The lotion/oil applicator of claim 15 wherein the cylinder is moveable by rotation about a longitudinal axis of the cylinder.

17. The lotion/oil applicator of claim 15 wherein the cylinder is moved longitudinally.

18. The lotion/oil applicator of claim 11 wherein the means for metering lotion/oil to the hollow interior portion of the roller includes:
a cylinder having a plurality of apertures;
a plurality of apertures being located on the cylinder;
a plurality of covers affixed to an actuating rod, the covers having a first position which covers the apertures and prevents passage of the lotion/oil through the apertures to the inner surface of the roller and a second position which removes the covers from the apertures to allow passage of the lotion/oil through the apertures; and
means for moving the covers from the first position to the second position.

19. A lotion/oil applicator for applying lotion/oil to a body of a user, said lotion applicator comprising:
an elongated handle having a storage area for storing the lotion/oil, said elongated handle having a first end and an opposite second end;
a roller applicator attached to the first end of said elongated handle, said roller applicator having a roller with a hollow interior portion, a moveable cylinder having a plurality of apertures positioned within the hollow interior portion, a plurality of channels leading from the cylinder to an inner surface of the roller;
the moveable cylinder moving between a first position wherein the plurality of apertures are aligned with the channels leading to the roller and a second position wherein the plurality of apertures are misaligned with the channels;
an actuating rod mechanically connected to an actuation button;
whereby the user actuates the actuation button causing the actuating rod to move the moveable cylinder to the first position to allow the lotion/oil stored within the elongated handle to run out through the plurality of apertures and the plurality of channels to the inner surface, thereby saturating the inner surface and soaking an outer surface of the roller and whereby the user applies the roller to the user to dispense lotion/oil to the user.
